(19) United States
(12) Patent Application Publication
(10) Pub. No.: US 2019/0182567 A1
(43) Pub. Date: Jun. 13, 2019

(54) ANTENNA ARRANGEMENT FOR WIRELESS CONFIGURATION OF A WIRED SENSING DEVICE

(71) Applicant: Honeywell International Inc., Morris Plains, NJ (US)

(72) Inventors: Sudheer Beligere, Bangalore (IN); Michael Moran, Plain City, OH (US); Sivaprakash Eswaran, Bangalore (IN); Vishal Malhan, Bangalore (IN); Brian Richards, Upper Arlington, OH (US)

(21) Appl. No.: 16/282,027

(22) Filed: Feb. 21, 2019

Related U.S. Application Data
(63) Continuation of application No. 15/444,630, filed on Feb. 28, 2017, now abandoned.

(51) Int. Cl. H04Q 9/00; H04B 5/00

(52) U.S. Cl. CPC H04Q 9/00; H04B 5/00; H04B 5/0043; H04Q 2209/50; H04B 5/0056; H04Q 2209/43; H04Q 2209/10; H04Q 2209/40; H04Q 2209/30

(57) ABSTRACT

Embodiments relate generally to systems and methods for collecting and communicating sensed data. A communication system may comprise a mobile device comprising a wireless communication module; and at least one sensor device located within a work area configured to monitor characteristics of the surrounding environment, wherein the sensor device comprises a controller; one or more sensors; a wired output configured to communicate sensor data from the one or more sensors via a wired connection; and a wireless interface comprising an antenna configured to communicate with the wireless communication module of the mobile device, wherein the mobile device is operable to receive and process the information received from the at least one sensor device. The antenna may at least partially extend from a housing of the sensor device. In some embodiments, the mobile device may not directly communicate with the central server.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A variety of sensors may be employed to determine characteristics of ambient air around the sensors. The sensors may be enclosed in a housing and placed in a location where it is desired by a user to know certain characteristics of the ambient air, such as temperature, humidity, air content (such as particulate matter and/or gases), as well as other information. Sensors may be stationary, in a fixed location, and/or mobile and carried by a user. Sensors may be located in hazardous work environments, and may comprise a protective housing to prevent damage to the internal components of the sensor.

### SUMMARY

In an embodiment, a field sensor device may comprise at least one sensor configured to detect one or more characteristics of the environment; a wired output configured to communicate sensed data from the at least one sensor; a wireless interface configured to communicate with one or more mobile devices; a housing configured to enclose at least a portion of the wireless interface; and a wireless antenna connected to the wireless interface, wherein a portion of the wireless antenna extends out of the housing.

In an embodiment, a communication system may comprise a mobile device comprising a wireless communication module; and at least one sensor device located within a work area configured to monitor characteristics of the surrounding environment, wherein the sensor device comprises a controller; one or more sensors; a wired output configured to communicate sensor data from the one or more sensors via a wired connection; and a wireless interface comprising an antenna configured to communicate with the wireless communication module of the mobile device, wherein the mobile device is operable to receive and process the information received from the at least one sensor device.

In an embodiment, a method for collecting and communicating sensed data may comprise establishing a wired communication link between a sensor device and a central server; establishing a wireless communication link between the sensor device and a mobile device, wherein the wireless communication link is established via an antenna that at least partially extends from a housing of the sensor device; receiving sensed data from one or more sensors of the sensor device; processing the sensed data; communicating the sensed data via the wired communication link to the central server; and communicating information from the sensor device to the mobile device via the wireless communication link.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a diagram of a communication system comprising a sensor device according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments of the disclosure include systems and methods for collecting and communicating sensed data via wired and wireless communication links. Field devices, or edge devices, such as sensors and transducers are used extensively in various environments and applications. Occasionally, there is need to communicate with such devices to identify, query, read and configure the devices.

A wired sensor may have a primary aim to work as a part of an overall control system, where the wired sensor may provide process (or sensed) data to the host system via a central server. The wired sensor may be mounted in a location where it is difficult to access the device and read the device information, such as the serial number, usable range, next calibration date etc. Additionally, in some applications, wired sensor devices may be preferred over wireless sensors, because wireless sensors and edge devices cannot match the speed and resolution performance expectations of wired devices with low power restrictions. This limits the usage of wireless technologies in real time sensing applications.

The relevant information that a user may wish to collect from a sensor device could be accessed via a display on the sensor device, but a display is not always fishable due to space and/or cost restrictions. Additionally, a user may wish to configure and/or test the sensor without disturbing the function of the sensor by removing the sensor from the wired communication with the central server. Some sensor devices may be built using metallic housings (or enclosures), which make it difficult for wireless signals to reach the internal components of the sensor. Due to space restrictions, it may also be difficult to mount external antennas on such devices.

Embodiments of the disclosure include methods and systems for establishing a wireless communication link with sensor devices, where the wireless communication link works reliably in metallic environments and provides a means to identify, query, read and if possible configure the sensor devices without disturbing the primary device connections or interfering with the setup.

The sensor device may comprise a wireless interface comprising an antenna arrangement, where the antenna extends at least partially from the housing and may be incorporated into a protective sheath of the wire connection to the sensor device. The described antenna arrangement may enable a mobile device to read the sensor device output data (most recent data, old max/min data, any alarm/anomaly data, current state), and the number of cycles used in the field since production. The sensing device may be any of a wired sensor, a transducer, and/or an edge device and may be configured to support wireless communication. A wireless reader (such as a mobile device) may read the sensor output, the maximum exposure of the sensor in the field through min/max data (to decide on warranty terms), alarms in case exceeding the rated specification, and min/max data showing the usage pattern of the sensor over time. The mobile device may communicate via application software that establishes the communication, and receives the sensor device details. Typical wired sensors offer no means of checking this data other than configuration settings. This wireless communication system would enable a user to read dynamic data and to make on spot decisions at the sensor location.

The described antenna arrangement may also enable a mobile device to read the sensor device profile data (serial number, device ID, model number, specifications, calibration data, past calibration records etc.). The mobile device may read the serial number of sensor, its performance specifications, range of the sensor, calibration records and its due calibration date. The mobile device may be used in test and measurement applications that help to maintain the systems in compliance with standards. The mobile device may allow for real-time calibration of equipment, and preventive maintenance which otherwise needs to be separately maintained in a centralized database.

The described antenna arrangement may also enable a mobile device to change the sensor device configuration (calibration data, tare, scaling, device ID etc.). Tare is an adjustment done to the sensor output, usually when subjected to use the transducers drift over time. This drift correction is called Tare adjustment. Scaling comprises adjusting the transducer output to the required level, for example instead of 2 mV/v, it can be adjusted to 2.5 mV/v if the user needs a different output value at different pressure levels and/or if the user wants to use this sensor for limited range. The wired device may be configured with no physical access. The wireless communication link enables adjusting calibration data and dual range calibration. Since the sensor device is also communicating via a wired connection, the changed configuration can be communicated to the central server, and may be monitored.

The described sensor device may be enabled to obtain device specific data from a web server to create relevant reports or compare with other nearby devices. Sensor calibration data may also be stored in a specific server in specific format, where the sensor device may wirelessly access and update the sensor specific data.

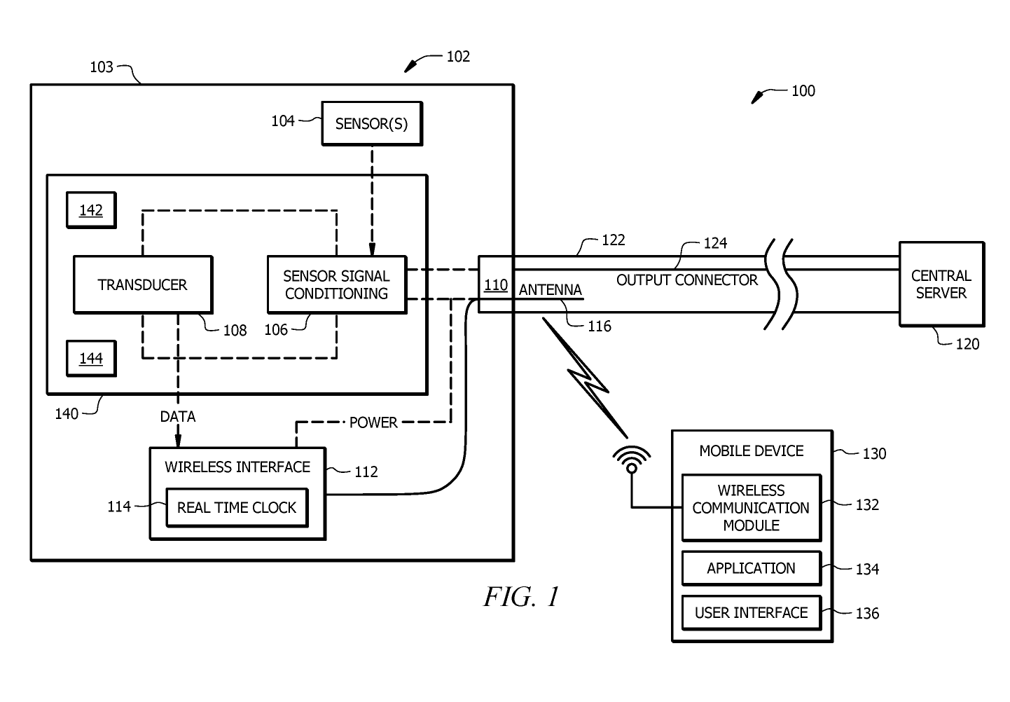

FIG. 1 illustrates a communication system 100 comprising a sensor device 102 configured to communicate with a central server 120 over a wired connection, and configured to communicate with a mobile device 130 over a wireless connection. The sensor device 102 may comprise a housing 103 configured to enclose and protect at least a portion of the components of the sensor device 102.

The sensor device 102 may be a “field device” that is installed in a particular location in a work environment. The sensor device 102 may be installed in a location where a hazardous environment is possible. The sensor device 102 may be a “wired” sensor device comprising a wired communication system configured to communicate sensed data from the sensor device 102. The communication system 100 shown in FIG. 1 may not be sized to scale, where FIG. 1 shows a diagram of the interactions between the different components. Additionally, the communication system 100 shown in FIG. 1 may comprise additional components that are not shown.

The sensor device 102 may comprise one or more sensors 104 configured to detect one or more characteristics of the environment, such as temperature, pressure, humidity, air quality, gas levels, sound, vibration, movement, particulate matter, etc. The sensor(s) 104 may be configured to communicate sensed data to a sensor signal conditioning system 106, which may process the sensed data via a transducer 108. The sensor signal conditioning system 106 and transducer 108 may be managed by a controller 140 comprising a processor 142 and a memory 144. The sensor signal conditioning system 106 may be analog or it may be a mixed signal circuit. The processed sensed data may then be communicated to the central server 120 via a wired output 110. The wired output 110 may comprise an output connector 124 which may be contained and protected by a wire sheath 122, and may extend to the central server 120.

The central server 120 may comprise a monitoring station configured to receive information from the sensor device 102, and optionally configured to receive information from a plurality of sensor devices. In some embodiments, the central server 120 may be accessed by a supervisor or monitor. In some embodiments, the central server 120 may be in communication with and/or may comprise a display which may be viewed by the supervisor or monitor.

The sensor device 102 may also comprise a wireless interface 112 configured to communicate wirelessly with one or more mobile devices 130. The wireless interface 112 may comprise an antenna 116, wherein at least a portion of the antenna extends out of the housing 103 of the sensor device 102. In some embodiments, the housing 103 may comprise a metal material, or another similar material, which may block wireless signals from entering the housing 103. Therefore, to provide wireless communication to and from the sensor device 102, it may be necessary for the antenna 116 to extend out of the housing 103. However, it may be desired to protect the antenna 116 from damage from the external environment. In some embodiments, the antenna 116 may be incorporated into the wire sheath 122 configured to protect the wired output connector 124. The antenna 116 may extend into a portion of the wire sheath 122, and may not interfere with the output connector 124 or wired output 110. In some embodiments, the wired output 110 may comprise an opening in the housing 103, and the antenna 116 may extend from the housing 103 via that same opening. The antenna 116 may extend outside the housing 103 to minimize the reflections and absorption of the wireless signals due to metallic objects (such as the housing and/or other components). The antenna 116 may be formed out of a connector terminal or a wire within the wire sheath (or cable) 122. The antenna 116 may comprise a separate antenna which is pasted on the output connector 124, housing 103, and/or wire sheath 122. The antenna 116 may be formed into the housing 103.

The wireless interface 112 may be configured to receive data via the transducer 108. The wireless interface 112 may also receive power via the controller 140 and/or sensor signal conditioning system 106. The wireless interface 112 can be self-powered using sensor power or powered by the controller. The wireless interface 112 may remain in a sleep mode until a wakeup signal is received from the mobile device 130.

The wireless interface 112 may be configured to communicate data from the controller 140 to the mobile device 130. For example, the wireless interface 112 may be configured to communicate sensor data from the one or more sensors 104 to the mobile device 130. As another example, the wireless interface 112 may be configured to communicate status information from the sensor device 102 to the mobile device 130. As another example, the wireless interface 112 may be configured to communicate settings information from the sensor device 102 to the mobile device 130.

In some embodiments, the wireless interface 112 may be configured to receive data from the mobile device 130 and communicate the received data to the controller 140. For example, the wireless interface 112 may be configured to receive instructions from the mobile device to the sensor device, and the controller 140 may be configured to implement the received instructions. The instructions may comprise a request for information, a change in settings, a change in status, or other similar instructions. The wireless interface 112 may comprise a real time clock 114 configured to associate time stamps with any information communicated to and/or from the wireless interface 112 of the sensor device 102. The wireless interface may comprise one or more of a Bluetooth interface, Wi-Fi interface, near-field communication (NFC) interface, radio frequency (RF) interface, any sub Gigahertz range, and any other wireless communication interface.

The mobile device 130 may comprise a wireless communication module 132 configured to facilitate wireless communication with the sensor device 102. The wireless communication module 132 may comprise one or more of a Bluetooth module, Wi-Fi module, near-field communication (NFC) module, radio frequency (RF) module, and any other wireless communication module.

The mobile device 130 may comprise a wireless reader, a mobile telephone, a smartphone, a tablet, a smartwatch, or any other similar mobile device which may be carried by a user. In some embodiments, the mobile device 130 may comprise an application 134 configured to control the communications to and from the sensor device 102, wherein the user may interact with the application 134 via a user interface 136. The user interface 136 may comprise one or more of a display, a touch screen, buttons, microphones, speakers, indicators, lights, etc.

In a first embodiment, a field sensor device may comprise at least one sensor configured to detect one or more characteristics of the environment; a wired output configured to communicate sensed data from the at least one sensor; a wireless interface configured to communicate with one or more mobile devices; a housing configured to enclose at least a portion of the wireless interface; and a wireless antenna connected to the wireless interface, wherein a portion of the wireless antenna extends out of the housing.

A second embodiment can include the field sensor device of the first embodiment, wherein the field sensor device is located in a hazardous environment.

A third embodiment can include the field sensor device of the first or second embodiments, wherein the portion of the wireless antenna that extends from the housing is incorporated into a wire sheath.

A fourth embodiment can include the field sensor device of any of the first to third embodiments, wherein the wired output comprises a wire sheath protecting an output connector.

A fifth embodiment can include the field sensor device of the fourth embodiment, wherein the portion of the wireless antenna that extends from the housing is incorporated into the wire sheath.

A sixth embodiment can include the field sensor device of any of the first to fifth embodiments, wherein the wireless interface comprises one or more of a Bluetooth interface, Wi-Fi interface, near-field communication (NFC) interface, radio frequency (RF) interface, and any other wireless communication interface.

A seventh embodiment can include the field sensor device of any of the first to sixth embodiments, further comprising a controller comprising a processor and a memory, wherein the controller is configured to receive sensed data from the one or more sensors, communicate the sensed data via one of the wired output and the wireless interface, receive instructions via one of the wired output and the wireless interface, and implement the received instructions.

An eighth embodiment can include the field sensor device of any of the first to seventh embodiments, wherein the wireless interface is configured to communicate one or more of: sensor data from the one or more sensors to the mobile device, status information from the sensor device to the mobile device, and settings information from the sensor device to the mobile device.

A ninth embodiment can include the field sensor device of any of the first to eighth embodiments, wherein the wireless interface is configured to receive instructions from the mobile device, and wherein the field sensor device is configured to implement the received instructions.

In a tenth embodiment, a communication system may comprise a mobile device comprising a wireless communication module; and at least one sensor device located within a work area configured to monitor characteristics of the surrounding environment, wherein the sensor device comprises a controller; one or more sensors; a wired output configured to communicate sensor data from the one or more sensors via a wired connection; and a wireless interface comprising an antenna configured to communicate with the wireless communication module of the mobile device, wherein the mobile device is operable to receive and process the information received from the at least one sensor device.

An eleventh embodiment can include the communication system of the tenth embodiment, wherein the wireless interface is configured to communicate sensor data from the one or more sensors to the mobile device.

A twelfth embodiment can include the communication system of the tenth or eleventh embodiments, wherein the wireless interface is configured to communicate status information from the sensor device to the mobile device.

A thirteenth embodiment can include the communication system of any of the tenth to twelfth embodiments, wherein the wireless interface is configured to communicate settings information from the sensor device to the mobile device.

A fourteenth embodiment can include the communication system of any of the tenth to thirteenth embodiments, wherein the wireless interface is configured to receive instructions from the mobile device to the sensor device, and wherein the controller is configured to implement the received instructions.

A fifteenth embodiment can include the communication system of any of the tenth to fourteenth embodiments, wherein at least a portion of the antenna extends from the housing via the wired output of the sensor device.

In a sixteenth embodiment, a method for collecting and communicating sensed data may comprise establishing a wired communication link between a sensor device and a central server; establishing a wireless communication link between the sensor device and a mobile device, wherein the wireless communication link is established via an antenna that at least partially extends from a housing of the sensor device; receiving sensed data from one or more sensors of the sensor device; processing the sensed data; communicating the sensed data via the wired communication link to the central server; and communicating information from the sensor device to the mobile device via the wireless communication link.

A seventeenth embodiment can include the method of the sixteenth embodiment, further comprising communicating the sensed data via the wireless communication link to the mobile device, wherein the mobile device does not directly communicate with the central server.

An eighteenth embodiment can include the method of the sixteenth or seventeenth embodiments, further comprising receiving instructions from the mobile device via the wireless communication link, and implementing the received instructions.

A nineteenth embodiment can include the method of any of the sixteenth to eighteenth embodiments, further comprising protecting the antenna via a wire sheath that extends from the housing of the sensor device.

A twentieth embodiment can include the method of any of the sixteenth to nineteenth embodiments, wherein the antenna extends from the housing via a wired output of the sensor device.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1.-20. (canceled)

21. A parameter sensing system comprising:
a wired sensor module comprising:
a sensor adapted to generate monitoring signals in response to detection of a sensed parameter by the sensor;
an electrically conductive housing defining a cavity that contains the sensor and adapted to substantially block radio frequency signals from entering or exiting the cavity;
a controller operably coupled to the sensor and configured to receive the generated monitoring signals, the controller comprising a sensor signal conditioning system and a transducer; and,
a wired interface operably coupled to the controller and adapted to electrically conduct electrical signals into and out of the cavity via a wiring assembly;
a wireless interface operably coupled to the controller and disposed in the cavity, such that the wireless interface is configured to generate an output signal upon receiving a data transmission signal from the controller; and,
an antenna:
(1) operably coupled to the wireless interface to receive and transmit the generated output signal,
(2) disposed at least partially outside of the electrically conductive housing, and,
(3) disposed at least partially along a length of the wiring assembly,
such that when the output signal is generated by the wireless interface, the output signal is radiated from a point on the antenna that is outside of the electrically conductive housing.

22. The system of claim 21, further comprising a mobile electronic device operably coupled in data communication with the controller via the antenna and wireless interface.

23. The system of claim 22, wherein the mobile electronic device is configured to receive an indication of the sensed parameter from the controller.

24. The system of claim 22, wherein the mobile electronic device is configured to receive an indication of sensor device profile data associated with the parameter sensing system from the controller.

25. The system of claim 22, wherein the mobile electronic device is configured to update a sensor device configuration associated with the parameter sensing system.

26. The system of claim 22, wherein when an update to the sensor device configuration is executed by the mobile electronic device, the controller transmits the update to the sensor device configuration to a central server.

27. The system of claim 22, further comprising a central server operably coupled in data communication with the controller via the wiring assembly and wired interface.

28. The system of claim 27, further comprising a wire sheath that encloses a portion of the wiring assembly and a portion of the antenna.

29. A parameter sensing system comprising:
a wired sensor module comprising:
a sensor adapted to generate monitoring signals in response to detection of a sensed parameter by the sensor;
an electrically conductive housing defining a cavity that contains the sensor and adapted to substantially block radio frequency signals from entering or exiting the cavity;
a controller operably coupled to the sensor and configured to receive the generated monitoring signals; and,
a wired interface operably coupled to the controller and adapted to electrically conduct electrical signals into and out of the cavity via a wiring assembly;
a wireless interface operably coupled to the controller and disposed in the cavity, such that the wireless interface is configured to generate an output signal upon receiving a data transmission signal from the controller; and,
an antenna:
(1) operably coupled to the wireless interface to receive and transmit the generated output signal,
(2) disposed at least partially outside of the electrically conductive housing, and,
(3) disposed at least partially along a length of the wiring assembly,
such that when the output signal is generated by the wireless interface, the output signal is radiated from a point on the antenna that is outside of the electrically conductive housing.

30. The system of claim 29, further comprising a mobile electronic device operably coupled in data communication with the controller via the antenna and wireless interface.

31. The system of claim 30, wherein the mobile electronic device is configured to receive an indication of the sensed parameter from the controller.

32. The system of claim 30, wherein the mobile electronic device is configured to receive an indication of sensor device profile data associated with the parameter sensing system from the controller.

33. The system of claim 30, wherein the mobile electronic device is configured to update a sensor device configuration associated with the parameter sensing system.

34. The system of claim 30, wherein when an update to the sensor device configuration is executed by the mobile electronic device, the controller transmits the update to the sensor device configuration to a central server.

35. The system of claim 30, further comprising a central server operably coupled in data communication with the controller via the wiring assembly and wired interface.

36. The system of claim 35, further comprising a wire sheath that encloses a portion of the wiring assembly and a portion of the antenna.

37. A parameter sensing system comprising:
a wired sensor module comprising:
a sensor adapted to generate monitoring signals in response to detection of a sensed parameter by the sensor, the sensed parameter selected from the group consisting of a temperature parameter, a pressure parameter, a humidity parameter, an air quality parameter, a gas level parameter, a sound parameter, a vibration parameter, a movement parameter, and a particulate matter parameter;
an electrically conductive housing defining a cavity that contains the sensor and adapted to substantially block radio frequency signals from entering or exiting the cavity;
a controller operably coupled to the sensor and configured to receive the generated monitoring signals; and,
a wired interface operably coupled to the controller and adapted to electrically conduct electrical signals into and out of the cavity via a wiring assembly;
a wireless interface operably coupled to the controller and disposed in the cavity, such that the wireless interface is configured to generate an output signal upon receiving a data transmission signal from the controller;
an antenna:
(1) operably coupled to the wireless interface to receive and transmit the generated output signal,
(2) disposed at least partially outside of the electrically conductive housing, and,
(3) disposed at least partially along a length of the wiring assembly,
such that when the output signal is generated by the wireless interface, the output signal is radiated from a point on the antenna that is outside of the electrically conductive housing.

38. The system of claim 37, further comprising a mobile electronic device operably coupled in data communication with the controller via the antenna and wireless interface.

39. The system of claim 38, wherein the mobile electronic device is configured to receive an indication of the sensed parameter from the controller.

40. The system of claim 38, wherein the mobile electronic device is configured to receive an indication of sensor device profile data associated with the parameter sensing system from the controller.
